(19) United States
(12) Patent Application Publication
(10) Pub. No.: US 2005/0005457 A1
(43) Pub. Date: Jan. 13, 2005

(54) Multipurpose firefighting and demolition implement

(76) Inventors: Dan L. Wensel, Phoenix, AZ (US); John P. Wozniak, Peoria, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/616,471

(22) Filed: Jul. 9, 2003

(51) Int. Cl. B26B 1/00

(52) U.S. Cl. 30/308.1; 30/164.8

(57) ABSTRACT

A multipurpose firefighting and demolition implement is disclosed. The implement uniquely combines the functions of at least three or more of the following: an axe, a shovel, a hoe, a pry bar, a hook, a claw, and a socket into one compact, toteable implement for use in firefighting and demolition. The implement comprises a dual-sided head with a handle mount in the middle. The front side of the head comprises a substantially flat front blade with a toothed edge on the edge of the blade opposite the handle mount. The front blade may also comprise a socket. The other side of the head comprises an axe blade. The axe blade includes a notched portion on either the upper surface, the lower surface, or on both of the upper and lower surfaces of the axe blade.

### FIELD OF THE INVENTION

The present invention relates to a multipurpose implement and, more particularly, to a toteable multipurpose implement useful in firefighting and demolition.

### BACKGROUND OF THE INVENTION

Fighting fires requires more than extinguishing a fire with a water source or firefighting foam. Fire fighters often need to force entry into buildings, remove impediments from their path, cover fires with dirt, and destroy and remove fuel from the fire's path and sift through debris to search for smoldering embers. Therefore, firefighters commonly carry and use several different implements or tools when fighting a fire. Some of these tools include an axe, a shovel, a pry bar, a pole with a hook and a claw. Depending on the type of fire, for example, structural or wild land fires, different combinations of these tools may be required.

However, when entering a fire, firefighters may not know which combinations of tools he or she may require once inside a structure or in the midst of a wild land fire. Already constrained by other gear, such as protective clothing, breathing apparatus and hose, firefighters can usually only carry one additional implement with them, for example an axe. Other tools must either be carried by other firefighters, or brought into the fire by additional personnel, when the other tools are needed.

Either situation poses the problem of a firefighter not having the proper tools when needed. The firefighter must seek out another firefighter with the proper tool or must radio to personnel outside the fire to have the proper tool brought in. Depending on the size of the structure or severity of the fire, neither option may be viable at a given time. Therefore, not only is the use of multiple tools inefficient and burdensome in firefighting, but the inability for a single firefighter to carry the complement of tools he or she may need while fighting a fire is inefficient and can also poses a serious risk to the safety of the firefighter.

Hence, there is a need for a single multipurpose implement that performs a variety of functions for firefighters to use in fighting all types of fires.

### SUMMARY OF THE INVENTION

The present invention provides a novel multipurpose implement for use in structural firefighting, wild land firefighting and construction demolition.

In one embodiment, and by way of example only, the firefighting implement comprises an axe blade and a front blade coupled to a handle mount and capable of being mounted on a handle shaft. The axe blade comprises an upper surface and a lower surface and a cutting edge. Either the upper or lower surface of the axe blade is a notched edge. The front blade is coupled to the axe blade at a handle mount and has a substantially flat upper surface, a substantially flat lower surface, a lateral edge, wherein the lateral edge is substantially perpendicular to the upper and lower surfaces, and a toothed edge on the extremity opposed to the cutting edge of the axe blade. In an alternate embodiment, both the upper and lower surfaces of the axe blade are notched edges. In a further alternate embodiment, the implement further comprises a sock, preferably located in the front blade, that is capable of removing one or more bolts used to secure fire hydrant caps.

In another exemplary embodiment, the firefighting implement is cast into single piece of metal, for example, titanium, and comprises an axe blade, with a cutting edge and a notched edge, wherein the notched edge can either be the upper or lower surface of the axe blade, a front blade with substantially flat upper and lower surfaces, a lateral edge substantially perpendicular to the upper and lower surfaces, and a toothed edge on the extremity opposed to the cutting edge of the axe blade.

Other independent features and advantages of the firefighting and demolition implement will become apparent from the following detailed description, taken in conjunction with the accompanying drawings which illustrate, by way of example, the principles of the invention.

### BRIEF DESCRIPTION OF THE DRAWINGS

FIG. 1 is a top view of one embodiment of the multipurpose firefighting and demolition implement;

FIG. 2 is a side view of one embodiment of the multipurpose firefighting and demolition implement; and

FIG. 3 is a perspective view of one embodiment of the multipurpose firefighting and demolition implement.

### DETAILED DESCRIPTION OF THE DRAWINGS

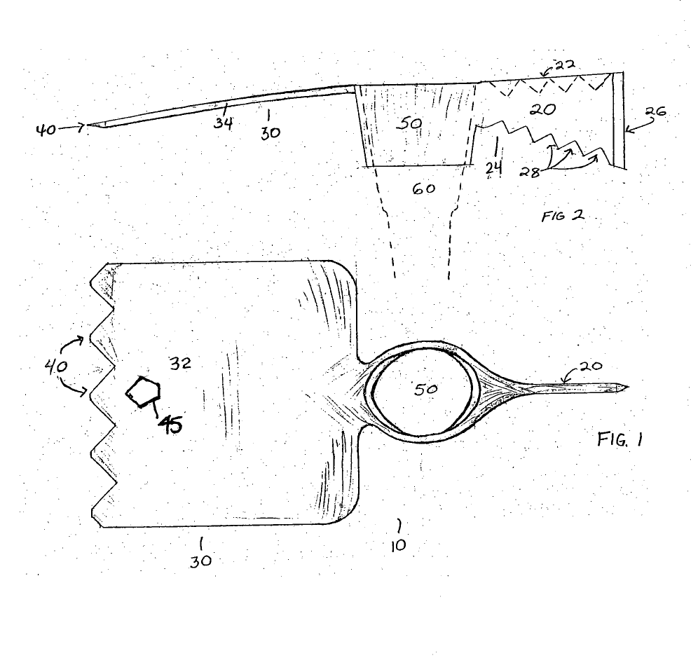

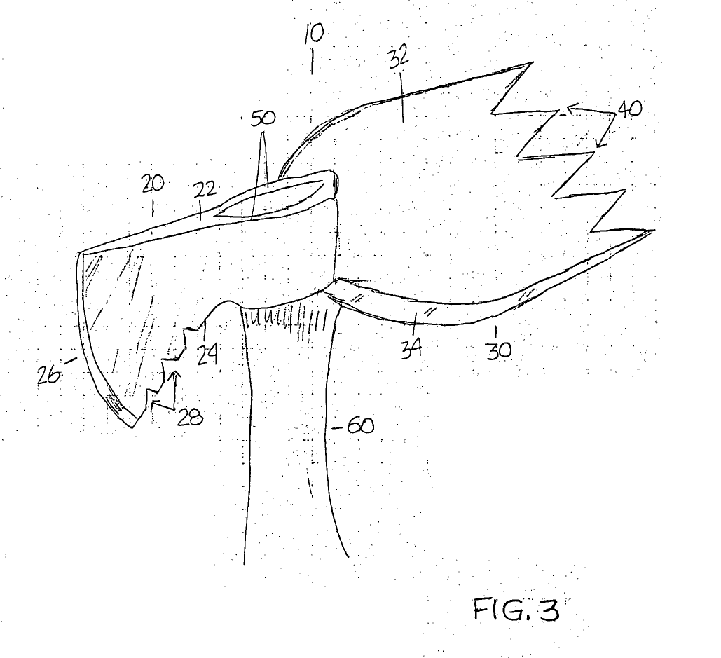

Referring to FIGS. 1-3, one embodiment of a multipurpose firefighting and demolition implement is shown. According to one embodiment, a multipurpose firefighting and demolition implement, firefighting implement 10, comprises a rear blade, axe blade 20, and a front blade 30. Referring specifically to FIGS. 2 and 3, axe blade 20 comprises upper surface 22, lower surface 24, cutting edge 26 and notched edge 28. Notched edge 28 is preferably lower surface 24 of axe blade 20; however, notched edge 28 may alternately be upper edge 22 of axe blade 20. In a further embodiment, axe blade 20 comprises a second notched edge 28, and therefore upper surface 22 and lower surface 24 are both notched edges 28. Depending on the particular application for which the firefighting implement is used, notched edge 28 has one or more notches that can be used as a hook, or otherwise used to grasp or hook hoses, wiring or plumbing. Notched edge 28 can also be used to grasp onto any object that would be pulled down from a ceiling or up from the flooring.

Axe blade 20 is preferably fabricated of a strong metal or metal alloy, such as aluminum or titanium. Using a strong lightweight metal, such as titanium, will decrease the overall weight of the implement, thus decreasing the effort required to tote the implement, for example, up stairs, through a large building, or even over a large distance, in the case of wild land fires. However, it will be appreciated that any suitable material known in the art may be used. Firefighting implement 10 can also be cast into single piece of metal, for example, titanium, to maximize uniformity and strength of firefighting implement 10. Axe blade 20 is capable of cutting electrical wiring or plumbing, including plumbing running inside a wall cavity. Further, axe blade 20 is capable of cutting a vent hole in a roof. Axe blade 20 is also capable of any other cutting job that axes known in the art are capable of.

According to one embodiment, the firefighting implement also comprises a handle mount 50, coupled to axe blade 20. The firefighting implement has an opening in handle mount 50, so that the firefighting implement is capable of being mounted on and affixed to handle shaft 60. Handle shaft 60 is preferably fabricated from wood, or a strong lightweight metal, such as aluminum or titanium. However, other materials, such as plastics or polymers may also be used for handle shaft 60. Handle shaft 60 is preferably about 100 centimeters in length, but it is recognized that handle shaft 60 may be of variable lengths, and may even be adjustable.

As shown in FIGS. 1, 2 and 3, front blade 30 comprises a substantially flat upper surface 32, a 'substantially flat lower surface (not shown), and a lateral surface 34 that is substantially perpendicular to the upper surface 32 and lower surface. Front blade 30 also comprises a toothed edge 40. Front blade 30 can be constructed of the same metal or metal alloy as axe blade 20, although, as with axe blade 20, any suitable material known in the art may be used. It is preferable that that axe blade 20 and front blade 30 are coupled together and mounted on handle shaft 60 (shown in FIGS. 2 & 3) at handle mount 50.

Thus, front blade 30, is a flat blade, approximately 2.0 cm thick, extending perpendicularly from handle mount 50 at any point along the vertical axis of handle mount 50, as shown in one embodiment in FIG. 2 and an alternate embodiment in FIG. 3. Front blade 30 terminates in toothed edge 40. Toothed edge 40 has one or more sharp teeth. Front blade 30 extends about 20 cm from handle mount 50 to toothed edge 40. Toothed edge 40 is approximately 25 cm in length. Thus, front blade 30 has a surface area of about 500 cm², which is the preferred area for most applications. The preferred surface area, which is approximately four times larger than a standard Mattock tool, is advantageous in removing large pieces of substrate materials. The large surface of front blade 30 prevents front blade 30 from breaking through the substrate material, and nearly full pieces of drywall can be removed. It is envisioned that firefighting implement 10 can be constructed in a variety of sizes, including, but not limited to a size similar to that of a hatchet or hammer, capable of being held in one hand and a larger size, similar to that of an axe or garden hoe.

In an alternate embodiment, firefighting implement 10 further comprises socket 45. Socket 45 is preferably located in front blade 30. Socket 45 can either be cut into front blade 30, or molded into front blade 30 of firefighting implement 10. Socket 45 is capable of loosening bolts, preferably one and a quarter to two inch size bolts, including, but not limited to fire hydrant bolts. Thus, because socket 45 is capable of removing fire hydrant bolts socket 45 can be used to remove fire hydrant caps and also to turn on and off the valve for the fire hydrant. Socket 45 operates in such a capacity by placing firefighting implement 10 over the hydrant bolt and lifting axe blade 20 to force the hydrant bolt into the front teeth of socket 45, using the rear tooth of socket 45 as a fulcrum. Lifting axe blade 20 above the plane of front blade 30 allows adjustment of socket 45 to the size of the hydrant or other bolt. Axe blade 20 is then used as the handle to turn socket 45.

Removing drywall in large pieces reduces the number of repetitive strokes needed to clear a section of drywall. Reducing time and effort in removing drywall while fighting a fire is valuable and may save additional lives. In the construction industry, removing larger pieces of drywall not only saves time and effort in the removal and dismantling from the wall process, but also saves time and energy in the clean-up of the debris following removal.

Furthermore, the large surface of front blade 30 is advantageous when using the firefighting implement to pry substrate materials because the large size of the front blade provides a large fulcrum and produces great leverage and a long pry length. In firefighting applications, this is advantageous in prying open a door that has a multiple lock system, for example, a dead bolt, an entry lock and a standard chain stop. The width of front blade 30 is wide enough to pry all three locks with the same pry movement, again saving time and effort in entering buildings or rooms in a building when firefighting.

Although one embodiment of front blade 30 has been described as having a preferable surface area of 500 cm², it is appreciated that front blade 30 may have different dimensions, resulting in a different surface area, depending on the application for which the firefighting implement is being used.

The firefighting and demolition implement is designed to give firefighters a multipurpose demolition tool to use in the chore of selective demolition during a structural fire. The firefighting implement is designed for the removal of substrate material such as drywall plaster, wood paneling, metal paneling and fiberglass reinforced panels, from interior wall and ceiling surfaces. The firefighting implement is also designed to remove exterior substrate materials such as Masonite siding, plywood or OSB sheer wall, plywood siding, metal sidings, exterior plaster and exterior finish and insulating systems from walls, soffets and roof systems. The firefighting implement is further designed for the removal of structural and non-structural members such as wood and metal studs framing, suspending ceiling systems, demountable office partitions, cabinets, case work and store fixtures.

The firefighting implement also has applications in wild land firefighting. The firefighting implement can be used as a hoe-axe combination, with front blade 30 with toothed edge 40 serving as an improved hoe or digging implement, and axe blade 10, being used as an axe to remove small trees, brush and other materials that could feed a wildfire. The multipurpose firefighting implement will allow firefighters to accomplish several of the firefighting tasks of fighting wild land fires, with one multipurpose implement instead of needing two or more.

The firefighting implement also has applications for the selective demolition requirements of the construction industry. As with firefighting, the construction industry has a need for a multipurpose tool that can pry, pull, cut and strike. This implement is ideal for the selective demolition required in the remolding, restoration and retrofit factions of the remodeling industry.

Therefore, the disclosed multipurpose firefighting and demolition implement combines the functions of several individual implements, such as an axe, a hoe, a pry bar, a hook, and a claw, into a single multipurpose toteable implement. The multipurpose firefighting and demolition tool may assist firefighters and increase the safety and efficiency of firefighting. Further, the multipurpose implement has numerous applications in the field of demolition to decrease the time and effort used to deconstruct substrate materials as well as structural members.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A firefighting implement, comprising:
an axe blade, wherein the axe blade comprises a cutting edge and a notched edge;
a handle mount, coupled to the axe blade at a surface opposed to the cutting edge of the axe blade, wherein the handle mount is capable of being coupled to a handle shaft; and
a front blade, coupled to the handle mount at a surface away from the axe blade, wherein the front blade comprises a substantially flat upper surface, a substantially flat lower surface, a lateral edge, wherein the lateral edge is substantially perpendicular to the upper surface and the lower surface, and a toothed edge, wherein the toothed edge of the front blade is on the extremity opposed to the cutting edge of the axe blade.

2. The implement of claim 1, further comprising a socket.

3. The implement of claim 2, wherein the socket is in the front blade.

4. The implement of claim 2, wherein the socket is capable of loosening fire hydrant bolts.

5. The implement of claim 1, wherein the notched edge of the axe blade is the lower surface of the axe blade.

6. The implement of claim 1, wherein the notched edge of the axe blade is the upper surface of the axe blade.

7. The implement of claim 1, further comprising a second notched edge.

8. The implement of claim 4, wherein the notched edge comprises a plurality of notches.

9. The implement of claim 1, wherein the toothed edge of the front blade comprises a plurality of teeth.

10. The implement of claim 1, wherein the front blade comprises titanium.

11. The implement of claim 1, wherein the axe blade comprises titanium.

12. The implement of claim 1, wherein the axe blade, the handle mount, and the front blade are contiguous.

13. The implement of claim 1, wherein the implement is cast into a single piece of metal.

14. The implement of claim 1, further comprising a handle.

15. The implement of claim 1, wherein the handle is adjustable.

16. A method of making a firefighting implement, comprising:
casting into a single piece of metal, a firefighting implement comprising:
an axe blade, wherein the axe blade comprises a cutting edge and a notched edge;
a handle mount to the axe blade at a surface opposed to the cutting edge of the axe blade, wherein the handle mount is capable of being coupled to a handle shaft; and
a front blade to the handle mount at a surface away from the axe blade, wherein the front blade comprises a substantially flat upper surface, a substantially flat lower surface, a lateral edge, wherein the lateral edge is substantially perpendicular to the upper surface and the lower surface, and a toothed edge, wherein the toothed edge of the front blade is on the extremity opposed to the cutting edge of the axe blade.

17. The method of claim 16, wherein the firefighting implement further comprises a socket.

18. The method of claim 17, wherein the socket is capable of loosening fire hydrant bolts.

19. The method of claim 16, wherein the notched edge of the axe blade is the lower surface of the axe blade.

20. The method of claim 16, wherein the notched edge of the axe blade is the upper surface of the axe blade.

21. The method of claim 16, wherein the notched edge of the axe blade comprises one notch.

22. The method of claim 16, wherein the notched edge of the axe blade comprises a plurality of notches.

23. The method of claim 16, further comprising coupling a handle to the handle mount.

24. A method of making a firefighting implement, comprising:
using an axe blade, wherein the axe blade comprises a cutting edge and a notched edge;
coupling a handle mount to the axe blade at a surface opposed to the cutting edge of the axe blade, wherein the handle mount is capable of being coupled to a handle shaft; and
coupling a front blade to the handle mount at a surface away from the axe blade, wherein the front blade comprises a substantially flat upper surface, a substantially flat lower surface, a lateral edge, wherein the lateral edge is substantially perpendicular to the upper surface and the lower surface, and a toothed edge, wherein the toothed edge of the front blade is on the extremity opposed to the cutting edge of the axe blade.

25. The method of claim 24, further comprising cutting a socket into the front blade.

26. The method of claim 24, further comprising coupling a handle to the handle mount.
